(19) United States
(12) Patent Application Publication
(10) Pub. No.: US 2014/0202940 A1
(43) Pub. Date: Jul. 24, 2014

(54) APPARATUS FOR A FLUID MIXING MODULE

(71) Applicant: GENERAL ELECTRIC COMPANY, Schenectady, NY (US)

(72) Inventor: Timothy Scott Shaffer, LaGrange, KY (US)

(73) Assignee: General Electric Company, Schenectady, NY (US)

(21) Appl. No.: 13/746,358

(22) Filed: Jan. 22, 2013

(51) Int. Cl. B01D 35/153

(52) U.S. Cl. CPC B01D 35/153
USPC 210/136; 137/511

(57) ABSTRACT

An apparatus includes a canister comprising a venturi component. The venturi component includes a check valve and a channel defined in the venturi component coupling the check valve to an interior cavity of the canister. Another apparatus additionally includes a plenum fluidly coupled to a venturi component via a channel defined in the venturi component such that a check valve only permits fluid to travel from the plenum into the canister.

### BACKGROUND

The subject matter disclosed herein relates generally to water filtration, and more particularly to sterilizing water streams into homes and the like.

Water filters are used to extract contaminants such as chlorine, chloramine, volatile organic compounds (VOCs), lead, microbes and other undesirable substances. The presence of some such contaminants is a direct result of agricultural chemicals, industrial and municipal wastewater facility processes, water treatment and disinfection byproducts, urban runoff and/or naturally occurring sources in ground water supplies. Others contaminants are introduced after treatment processes within the home and/or municipal sources, for example, from piping and contact with contaminant items.

Household filters can generally be broken into two classes: Point of Entry (POE) filters and Point of Use (POU) filters. POE filters are placed at the entry point of water into the home and continuously filter all water that enters the home. POU filters are installed in areas such as kitchen sinks and refrigerators where water may be used for direct consumption.

A water filter system includes inlet/outlet tubing, a manifold and a filter component. The manifold receives untreated water, directs the water into a filter media, which subsequently directs the treated/filtered water back out for use. The filter media can vary depending on the contaminants targeted for removal. Sediment filters will take out fairly coarse particulate matter greater than 10 microns. Carbon filters, which generally include 60-70% carbon, 2-5% scavenger additives such as titantium dioxide, and 25-40% polyethylene binder dust, will extract contaminants such as chlorine, lead, VOCs, pharmaceuticals, particulates larger than 0.5 microns, and some large microbes such as cysts. The scavenger additives are included to shore-up the block's ability to remove those contaminants that carbon does not have an affinity to adsorb such as heavy metals like lead. Hollow fiber technology, ozone, ultraviolet (UV) lamps and quaternary technologies are also used to extract or destroy microbes, which can be as small as 0.015 microns. In virtually all cases, the filter media will be exhausted over time and use and need to be replaced in order to restore the system's ability to remove contaminants.

Water filtration systems as described above, however, are generally incapable of eliminating or eradicating micro-organisms or other types of contaminants not extracted by standard filter media. Therefore, a need exists to incorporate a sterilization agent capable of eliminating or extracting such types of micro-organisms and/or contaminants from the water that passes through a filtration system.

Moreover, existing point-of-use water filter systems lack a canister compatible with existing filter heads that can dose a sterilization agent into water at a preset concentration. Accordingly, a need exists for an apparatus or component compatible with existing filter heads that can be utilized in implementations of sterilization techniques by introducing determined amounts of sterilization liquids at desired concentrations into the fluid passing through a corresponding filtration system to kill micro-organisms present therein.

### BRIEF DESCRIPTION OF EXAMPLE EMBODIMENTS OF THE INVENTION

As described herein, the exemplary embodiments of the present invention overcome one or more disadvantages known in the art.

A first aspect of the present invention relates to an apparatus comprising a canister comprising a venturi component, wherein the venturi component comprises a check valve and a channel defined in the venturi component coupling the check valve to an interior cavity of the canister.

A second aspect of the present invention relates to an apparatus comprising a canister comprising a venturi component, wherein the venturi component comprises a check valve and a channel defined in the venturi component coupling the check valve to an interior cavity of the canister, and a plenum fluidly coupled to the venturi component via the channel defined in the venturi component such that the check valve only permits fluid to travel from the plenum into the canister.

As described herein, the apparatus of the above first and/or second aspect of the invention can include a fluid mixing module employed within the canister, wherein the fluid mixing module is coupled to a component (for example, a plenum body) such that fluid can be directed into the fluid mixing module, generating a vacuum in that pulls contents of the component into the fluid through the fluid mixing module. Accordingly, such apparatus can be utilized in implementations of sterilization techniques, as the contents of the component can include sterilization liquids such as chlorine, fluoride, bleach, etc. Further, as also additionally described herein, such sterilization liquids can be diluted to desired or standard concentrations and implemented to kill most micro-organisms present in the fluid passing through a corresponding filtration system.

A third aspect of the present invention relates to a fluid filtration system incorporating the apparatus described in the first or second aspect of the invention above, the fluid filtration system comprising a manifold having a manifold inlet port and a manifold outlet port, a check valve being disposed for fluidly sealing at least one of said ports, a flow inlet channel leading to the check valve, the manifold inlet port being operably fluidly coupled to a fluid source for receiving a flow of fluid and to a flow inlet channel, the manifold outlet port being fluidly coupled to a flow outlet channel; the flow inlet channel having an intake opening for directing fluid conveyed therein, the intake opening defined in a margin of a depending inlet boss of the manifold; and an outlet boss depending from the inlet boss and having a circumferential outer margin, the outlet boss also having an outlet opening for directing fluid conveyed therein, the outlet opening being fluidly coupled to the flow outlet channel, the flow outlet channel fluidly coupling the outlet opening to the manifold outlet port.

These and other aspects and advantages of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. Moreover, the drawings are not necessarily drawn to scale and, unless otherwise indicated, they are merely intended to conceptually illustrate the structures and procedures described herein.

### BRIEF DESCRIPTION OF THE DRAWINGS

In the drawings:

FIG. 1 illustrates a water filter apparatus, in accordance with a non-limiting example embodiment of the invention;

FIG. 2 illustrates components of a water filter apparatus, in accordance with a non-limiting example embodiment of the invention;

FIG. 3 illustrates components of a filter canister, in accordance with a non-limiting example embodiment of the invention;

FIG. 4 illustrates a cross-section view of a water filter apparatus, in accordance with a non-limiting example embodiment of the invention;

FIG. 5 illustrates an uninstalled position and installed position of a manifold and filter canister, in accordance with a non-limiting exemplary embodiment of the invention;

FIG. 6 illustrates a side view image of a bayonet, in accordance with a non-limiting example embodiment of the invention;

FIG. 7 illustrates exploded and cross-section views of the filter canister cap and insert component, in accordance with a non-limiting example embodiment of the invention;

FIG. 8 presents a filter canister, within which a fluid mixing module is displaced, in accordance with a non-limiting exemplary embodiment of the invention;

FIG. 9A, FIG. 9B and FIG. 9C present cross-section views of sterilization module components, in accordance with a non-limiting exemplary embodiment of the invention; and

FIG. 10 presents a mixing column, in accordance with a non-limiting exemplary embodiment of the invention.

### DETAILED DESCRIPTION OF EXAMPLE EMBODIMENTS OF THE INVENTION

As described herein, one or more embodiments of the invention include an apparatus for a fluid mixing module. For example, at least one embodiment of the invention includes a fluid mixing module employed within a water filter canister. As described in further detail herein, a fluid mixing module can be coupled to a plenum body attached to a module body that includes a venturi component and a mixing column at an exhaust port. Fluid can be directed into the fluid mixing module, generating a vacuum in the plenum body , which pulls contents from the plenum (for example, sterilization liquids such as chlorine, fluoride, bleach, etc.) into the fluid through the mixing column.

In at least one embodiment of the invention, dosage of such contents can be controlled in part by the given geometry of the venturi component. By way merely of example, for a given geometry, liquid such as chlorine can be drawn from the plenum at a particular rate such as to provide for an 8% solution of chlorine.

Additionally, at least one embodiment of the invention can be implemented within the context of a water filtration system, such as detailed below.

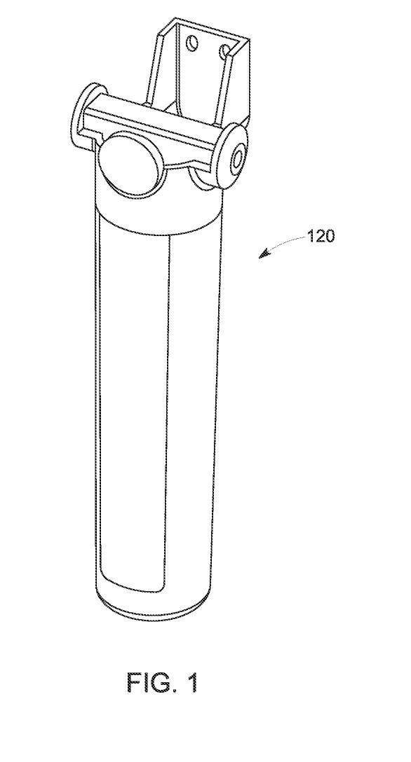

FIG. 1 illustrates a water filter apparatus 120, in accordance with a non-limiting exemplary embodiment of the invention. Individual components that constitute water filter apparatus 120 are depicted in the subsequent figures, and the individual components illustrated therein (as well as the numerical labels corresponding thereto) are used herein in describing one or more embodiments of the invention.

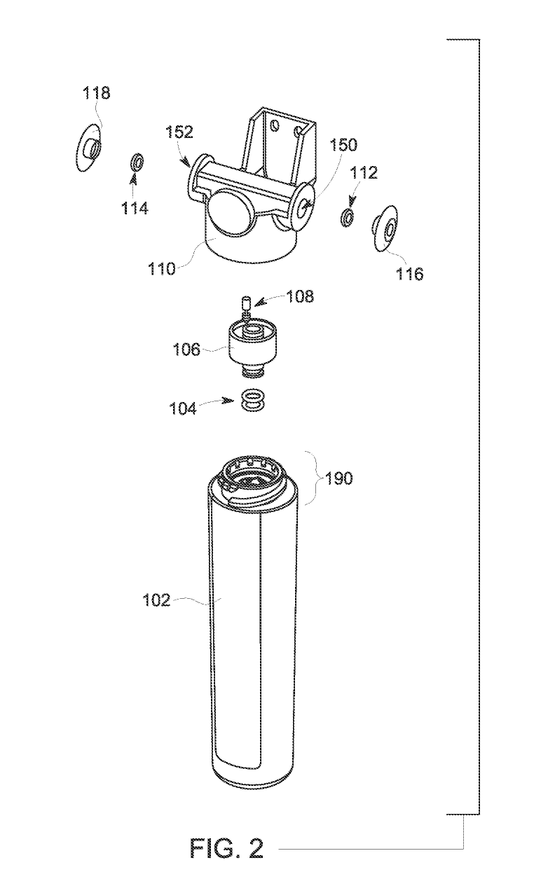

Accordingly, FIG. 2 presents components of the water filter apparatus 120 of FIG. 1, in accordance with a non-limiting exemplary embodiment of the invention. By way of illustration, FIG. 2 depicts a filter canister 102, o-rings 104, a bayonet 106, a check valve 108, a manifold body 110, o-ring 112 and o-ring 114, and speed-fit cap 116 and speed-fit cap 118. As shown in FIG. 2, the filter canister 102 additionally includes an annular canister interlocking member 190. Additionally, the manifold body 110 includes a manifold inlet port 152 and manifold outlet port 150. These components are discussed in further detail herein.

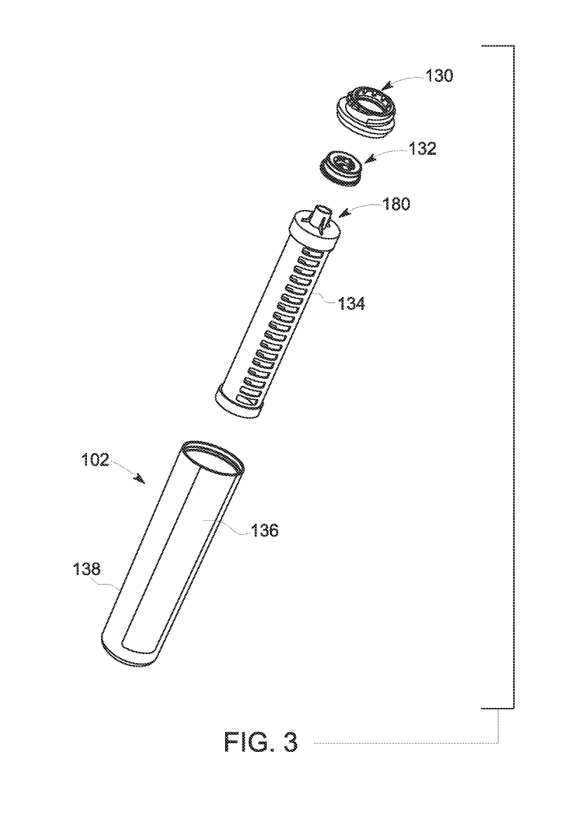

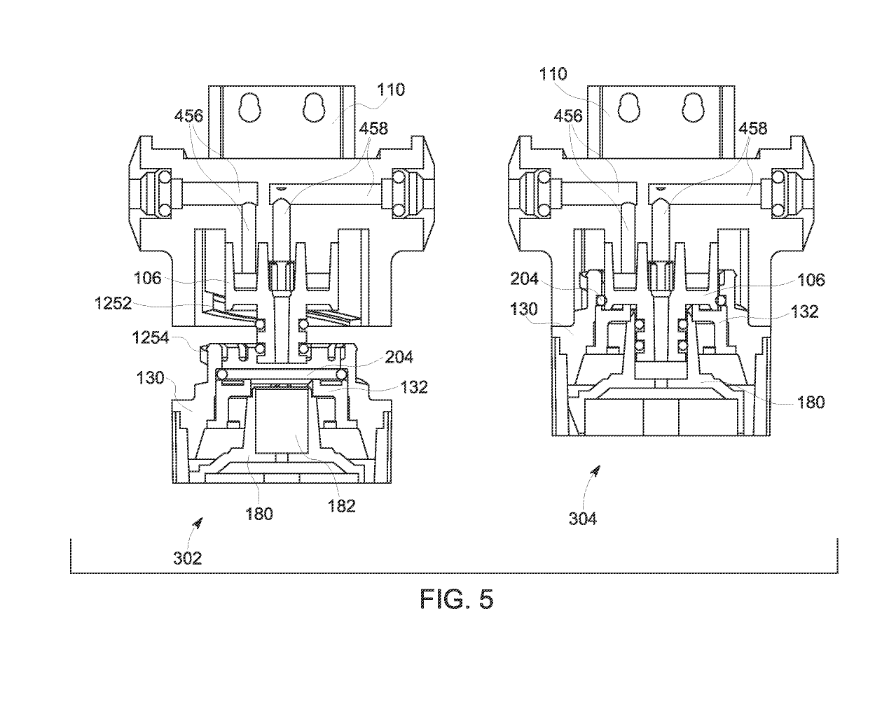

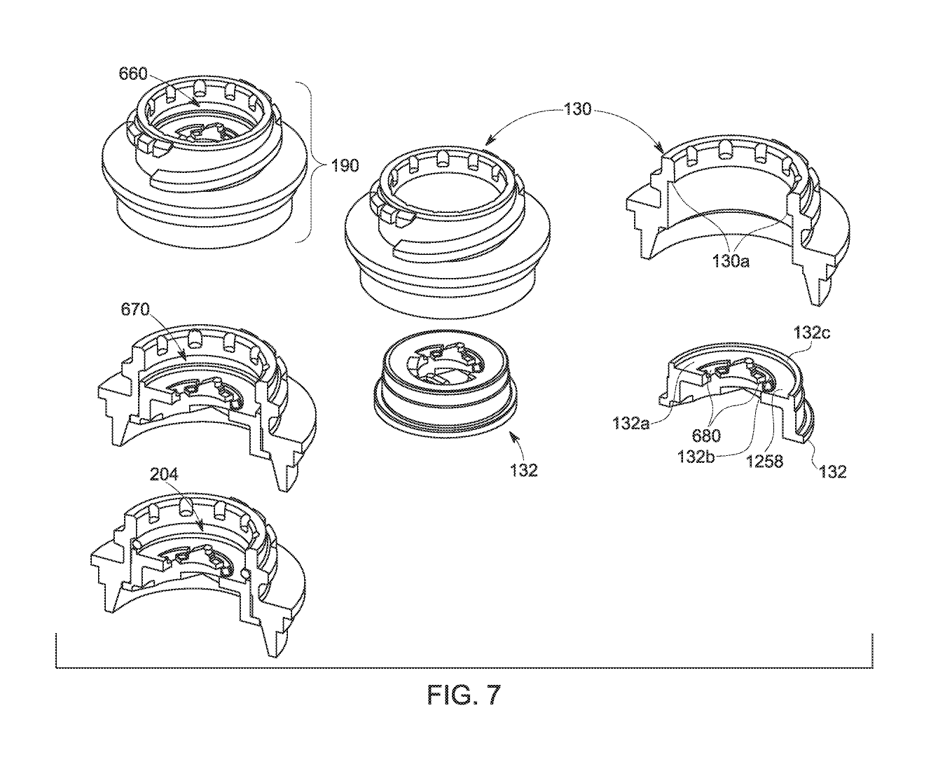

FIG. 3 illustrates components of the filter canister 102, in accordance with a non-limiting exemplary embodiment of the invention. By way of illustration, FIG. 3 depicts a filter cap 130 and an insert component 132, which comprise the annular canister interlocking member 190. In at least one embodiment of the invention, the annular canister interlocking member 190 can include a compression seal (such as, for example, in the form of an o-ring 204 as depicted in FIG. 5 and FIG. 7) positioned on the inner surface of the member 190. Additionally, in at least one embodiment of the invention, the insert component 132 enables various methods of engaging the check valve 108. The engagement amount of the check valve 108 can vary from, for example, 0.050 inches to 0.1875 inches depending on how far the check valve is to be pushed up. In an example embodiment, a 1/16″ diameter o-ring can be pushed around the check valve 108 up almost 1/16″ to break seal. Additional embodiments can include pushing higher (0 to 0.125″) to facilitate higher flow rates if desired or needed. Accordingly, in at least one embodiment of the invention, the check valve 108 engages the insert component 132 upon rotation of the filter canister 102 upon an approximately quarter turn of the filter canister 102, opening a passage-way through which fluid can pass.

FIG. 3 also depicts a media adapter cap 180 and a filter media structure assembly 134. As known in the art, the filter media structure assembly 134 can include one of multiple compositions. For example, the structure assembly can include carbon, a reverse osmosis membrane, an ultra-filtration component (such as a hollow fiber cartridge), etc. Additionally, as depicted in FIG. 3, the filter canister 102 can include a polypropylene canister portion 136 and a soft touch santoprene canister portion 138.

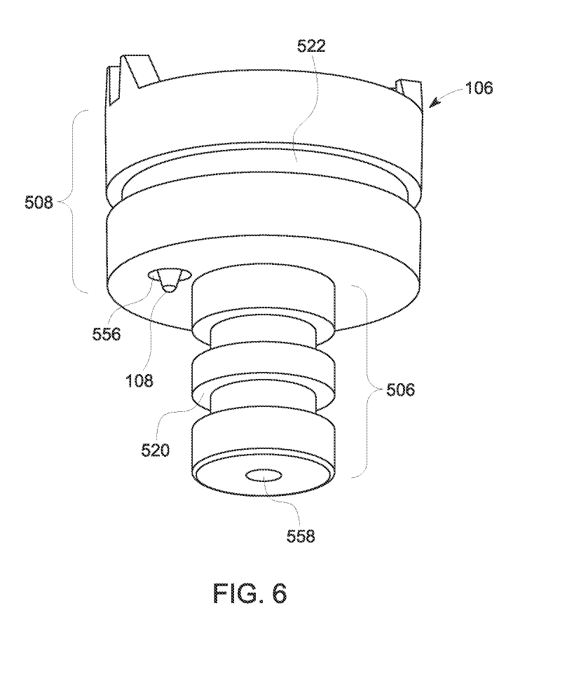

Also, at least one embodiment of the invention includes attaching a cartridge to a water filter head assembly, and more specifically, at least one embodiment of the invention includes adding an elastomeric seal component (such as, for example, o-ring 204 as depicted in FIG. 5 and FIG. 7) to the mating surface provided by the inner periphery of the annular canister interlocking member 190 to sealingly engage the external cylindrical surface of the inlet boss portion (depicted as component 508 in FIG. 6) of the bayonet 106 as the filter canister 102 is installed.

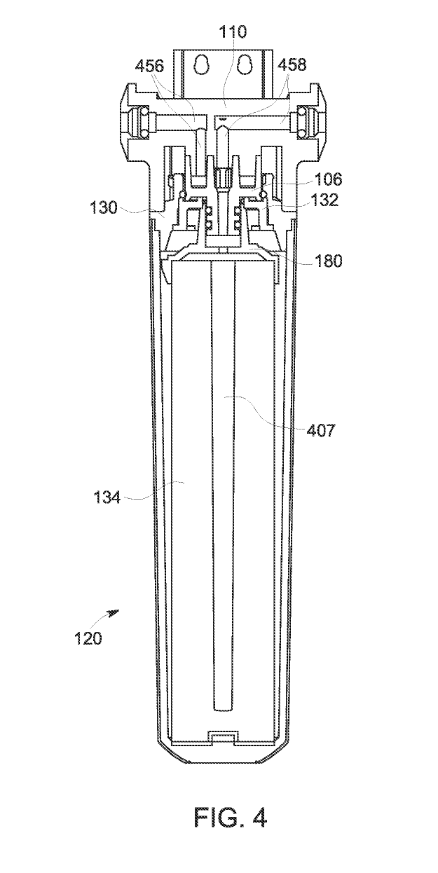

FIG. 4 illustrates a cross-section view of water filter apparatus 120, in accordance with a non-limiting exemplary embodiment of the invention. Specifically, FIG. 4 shows manifold body 110, bayonet 106, a flow inlet channel 456 defined within the manifold body 110 leading to the check valve 108, and a flow outlet channel 458 defined in the manifold body 110. The manifold inlet port 152 is operably fluidly coupled to a fluid source for receiving a flow of unfiltered fluid, and is also fluidly coupled to the flow inlet channel 456. The manifold outlet port 150 is fluidly coupled to flow outlet channel 458.

FIG. 4 also shows filter canister cap 130, insert component 132, media adapter cap 180, and the filter media structure assembly 134. As is known in the art, there are commonly two different filter media structure assembly types—carbon blocks and hollow fiber. The hollow fiber includes a plastic outer shell that contains the hollow fiber into a bundle. This bundle is potted in the shell such that water passes from outside the fibers into the center of individual fibers, where it flows through the fiber to a common outlet atop the cartridge. The insert component 132 (or in one or more embodiments, the filter canister cap 130) includes a centrally located hole or channel on the horizontal surface that acts to locate the filter media structure assembly 134 radially within the filter canister 102 and direct fluid thereto. The upwardly extending cylindrical portion of the cap 180 fits into the centrally located hole in insert component 132 to locate the media. Further, the media adapter cap 180 can be a portion of the filter media structure assembly 134 or coupled to the filter media structure assembly 134 as a separate component.

As noted above, new filters are being engineered to extract more contaminants at higher flow rates due to changes in both the media and filter geometry. By way of example, cartridges filled with hollow fiber media can be capable of removing bacterial and viral microorganisms down to a 15 nanometer size. Another media, as mentioned, includes a traditional carbon block, where the surface area has been increased by almost 50% but volume correspondingly only by approximately 20%.

FIG. 5 presents an image representing the uninstalled position 302 and installed position 304 of the manifold body 110 and filter canister 102, in accordance with a non-limiting exemplary embodiment of the invention. In addition to the components also depicted in FIG. 4, FIG. 5 illustrates a spiraling shoulder flange 1252 on the manifold body 110 and a flange 1254 on the filter canister cap 130. Rotation of the flange 1254 on the filter canister cap 130 with respect to the manifold flange 1252 on the manifold body 110 acts to engage the filter canister 102 and the manifold body 110 and draw them together in an axial direction into a tight fit. Additionally, FIG. 5 identifies o-ring 204, which is described further in connection with FIG. 7. Moreover, the uninstalled 302 and installed 304 position of the manifold body 110 and filter canister 102 depicted in FIG. 5 illustrate how the bayonet 106 fits into the filter canister 102 and more specifically how inlet boss (depicted as component 508 in FIG. 6) of the bayonet 106 is received in sealing engagement with a first mating surface provided in this embodiment by an interior annular surface 660 of interlocking member 190, which is formed by the inner surface of the side wall of cap 130 together with the upwardly extending outer rim 132c of insert component 132, as further illustrated in FIG. 7.

Additionally, FIG. 5 depicts how outlet boss 506 is received into the inlet annular recess defined in this embodiment by the hollow cylindrical interior 182 of media adapter cap 180 and seals off against a second mating surface illustratively embodied by the interior surface of the upwardly extending cylindrical sidewall of the media adapter cap 180.

FIG. 6 illustrates a side view image of bayonet 106. As described herein, bayonet 106 is a protrusion that comes down off of the bottom of the manifold body 110 for sealing engagement with the filter canister 102. As noted, the bayonet 106 can, by way of example, be welded via ultrasonic, spin, or heat-stake means into the manifold body 110, thereby establishing a water flow path. The smaller diameter portion, also referred to herein as an outlet boss 506 of the bayonet 106, which includes annular spaces 520 for fitting o-rings 104 if desired, fits into the hollow cylindrical interior 182 of media adapter cap 180 in the middle of filter canister 102 to form a seal therebetween. By way of illustration, FIG. 4 depicts a double o-ring seal engaging the media adapter cap 180 of the filter media, wherein the o-rings (such as depicted as components 104 in FIG. 2) squeeze into the media adapter cap 180 to form a seal.

The fluid exiting the filter travels up through the flow outlet channel 458 (as depicted in FIG. 4) in the middle of the bayonet 106 and is ultimately directed out of the manifold body 110. The seal between outlet boss 506 and the filter canister 102 prevents the water exiting the filter canister 102 from leaking around outlet boss 506. The larger diameter portion, also referred to herein as an inlet projection or inlet boss 508 of the bayonet 106, provides a surface for sealingly engaging the filter canister 102 and more particularly for sealingly engaging a mating surface provided in this embodiment by an interior annular surface 660 of interlocking member 190, which is formed by the inner surface of the side wall of cap 130 together with the outer rim 132c of insert component 132, as hereinafter more fully described in reference to FIG. 7, to prevent the unfiltered fluid entering the filter canister 102 through the check valve 108 from leaking to the ambient environment outside of the manifold body 110.

As described and depicted herein, bayonet 106 includes the flow inlet channel 456 (as depicted in FIG. 4) around check valve 108 having a discharge opening 556 for discharging the fluid conveyed therein to the filter canister 102. The discharge opening 556 is defined in a lower margin of depending inlet boss 508. The inlet boss 508 has a circular cross section defined about a longitudinal axis and a circumferential outer margin. The discharge opening 556 is radially displaced from the longitudinal axis. Boss sealing means can include o-rings positioned in annular space 522 to seal the space between the inlet boss 508 and the inner periphery of the filter canister cap 130 when fully assembled. Additionally, an outlet opening 558 is fluidly coupled to the flow outlet channel 458. Further, the flow outlet channel 458 fluidly couples the outlet opening 558 to the manifold outlet port 150.

Accordingly, the bayonet 106 receives fluid flow from the manifold inlet port 152 in the manifold body 110. The bayonet 106 distributes the flow into the inlet boss 508 to the discharge opening 556 defined in the lower margin of the bayonet 106. Further, as is known in the art, structural support features above the discharge opening 556 can be provided to align and guide the movement of the check valve 108 along the longitudinal axis of the discharge opening 556.

As noted above, when engaged with the filter canister 102, the large diameter cylinder or inlet boss 508 provides a sealing surface for engagement with a first mating surface provided by an interior annular surface 660 of interlocking member 190, which is formed by the inner surface of the side wall of cap 130 together with the upwardly extending rim 132c of insert component 132, to provide a seal between the incoming, unfiltered fluid and ambient environment. The smaller diameter cylinder or outlet boss 506, when engaged with the filter canister 102, fits and forms a seal against cylindrical interior 182 of media adapter cap 180 and directs filtered fluid toward the exit of the manifold body 110. Each of these bayonet cylinders may, merely by way of example, include an o-ring or a set of o-rings as well as a set of glands to facilitate a proper seal.

On the bottom horizontal surface of the inlet boss 508, a plunger of the check valve 108 protrudes downward and is biased into this position via a mechanical spring within the check valve 108. This plunger is depressed upward as it engages a complementary surface on the filter canister 102 when the filter canister 102 is being installed in the manifold body 110, which surface may comprise recessed sumps or raised protrusions, depending on orientation of the check valve, as is known in the art.

FIG. 7 illustrates exploded and cross-section views of the filter canister cap 130 and insert component 132. Additionally, FIG. 7 depicts the annular canister interlocking member 190, including the interior annular surface 660 of interlocking member 190, which comprises a first mating surface as detailed herein. Further, FIG. 7 depicts an o-ring groove 670 for receiving and retaining o-ring 204. The groove 670 is formed, in the embodiment illustrated in FIG. 7, in the first mating surface formed by the upper edge of rim 132c on the insert component 132 and the inner bottom annular surface 130a on the filter canister cap 130 proximate the intersection of cap 130 and insert component 132. Additionally, the insert component 132, in at least one embodiment of the invention, is spun welded into the filter canister cap 130. In an example embodiment, the o-ring 204 sealingly engages the vertical walls of the inlet boss 508 of the bayonet 106 during installation in lieu of and/or conjunction with an existing o-ring installed on the outlet boss 506 of the bayonet 106. Specifically, as detailed herein, boss sealing means of the bayonet 106 include o-rings 104 positioned in annular spaces 520 to seal the space between the outlet boss 506 and the second mating surface, provided in the embodiments herein described by the inner periphery of the filter canister cap 130, when fully assembled.

FIG. 7 also depicts an annular recess 1258 formed by the upper facing surface 132a of the insert component 132, extending between inner upwardly extending rim 132b and outer upwardly extended rim 132c, as well as slot features 680 located around the inner hole of the insert component 132. In at least one embodiment of the invention, fluid entering via discharge opening 556 in inlet boss 508 travels into the inlet recess 1258 between the bayonet 106 and the surface 132a of the insert component 132 into the interior space between the filter canister cap 130 and the exterior surface of the media adapter cap 180, through the slot features 680 located around the central hole in the insert component 132. From this region the water flows into the space between the filter media and the cylindrical wall of canister 102 and then radially inwardly through filter media structure assembly 134 to the central bore media structure 407 of the assembly 134 and exits the canister through the central opening in cap 180 to outlet channel 458 of manifold 110 which passes through outlet boss 506.

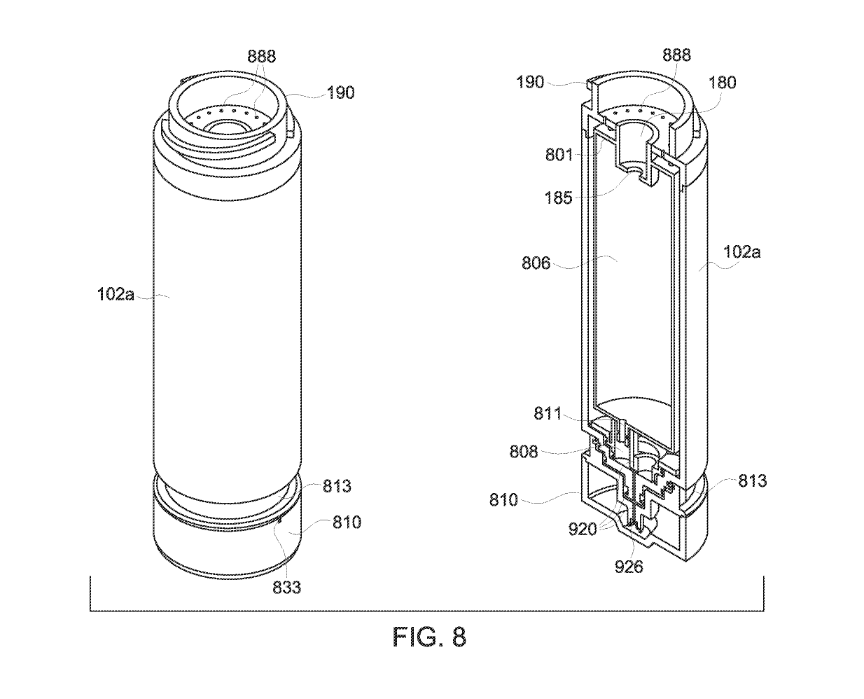

As noted above, at least one embodiment of the invention includes a fluid mixing module employed within a filter canister 102a. As detailed below in connection with FIGS. 8-10, an example fluid mixing module is coupled to a plenum body (also referred to herein as a sump), wherein the plenum is attached to the module body which includes a venturi component and a mixing column at an exhaust port. When the module assembly is attached to the plenum body, fluid can be directed into the module, generating a vacuum in the plenum body to pull contents of the plenum into the fluid through the mixing column.

As used in examples herein, the plenum can be constructed such as to be capable of containing or holding fluids such as sterilization liquids (chlorine, fluoride, bleach, etc.). By way of example, a sterilization technique within a water filtration system context can include the use of bleach (chlorine), which uses an active ingredient of sodium hypochlorite, commonly diluted to a 1/10 concentration, to kill most micro-organisms present in the water passing through the filtration system.

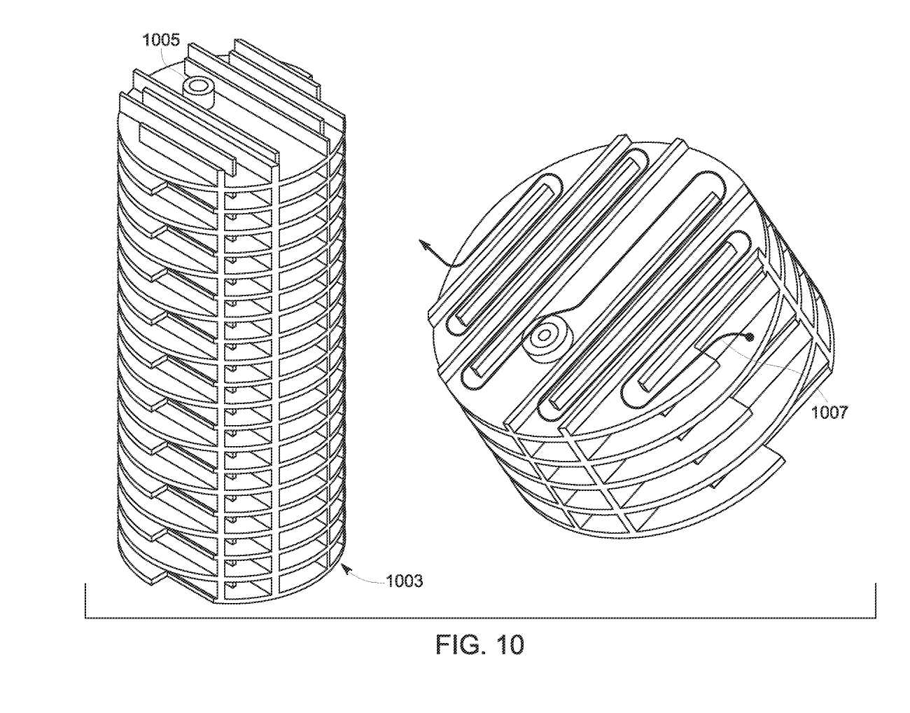

Accordingly, FIG. 8 presents filter canister 102a, which includes a fluid mixing module 801, in accordance with a non-limiting exemplary embodiment of the invention. Specifically, FIG. 8 depicts annular canister interlocking member 190 (such as described in connection with FIGS. 2 and 3) of filter canister 102a, which includes through-holes 888 defined on a surface of the canister interlocking member 190, which also includes media adapter cap 180 (with a central opening 185 defined therein) coupled thereto. Additionally, FIG. 8 depicts an internal module body cavity 806 of fluid mixing module 801, which can receive a mixing column (such as depicted in FIG. 10). The fluid mixing module further includes an exhaust port 811. The fluid mixing module 801 is coupled to the media adapter cap 180 such that fluid can exit the internal module body cavity 806 through central opening 185 out of the filter canister 102a and ultimately into the manifold body (such as component 110, described herein).

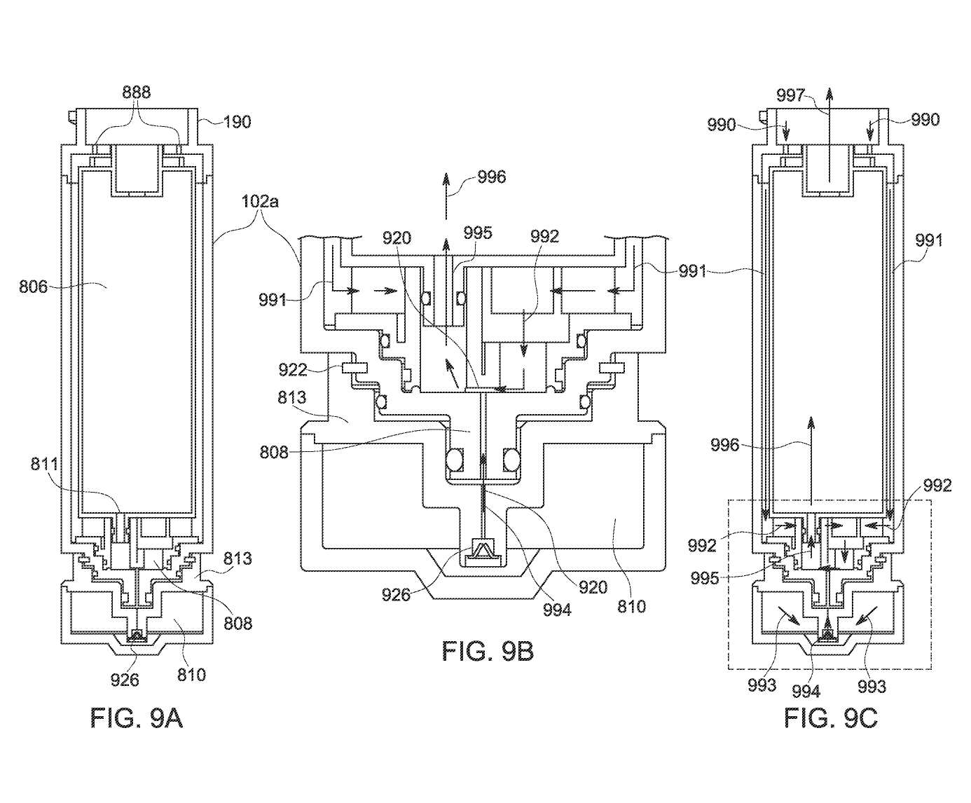

FIG. 8 also depicts a venturi component 808, a chemical additive module 813 (which houses a check valve 926) and a plenum 810. The plenum 810 can be a vented plenum via the inclusion of a vent hole 833, which supports the suction created by the venturi. In an example embodiment of the invention, the vent hole 833 in the plenum 810 is approximately 0.02″×0.02″ in size. As illustrated in the example embodiment in FIG. 8, the venturi component 808 is disposed within the filter canister 102a in conjunction with the fluid mixing module 801, wherein the venturi component 808 is fluidly connectable to the exhaust port 811 of fluid mixing module 801. Additionally, the chemical additive module 813 is coupled to the plenum 810 as well as to an exterior surface of the filter canister 102a. By way of example, the plenum 810 can include a snap-on interface to facilitate coupling to the chemical additive module 813. As further described in connection with FIG. 9A, FIG. 9B and FIG. 9C, chemical additive module 813 houses check valve 926, which can enable the uptake of fluid from the plenum 810 into a venturi channel 920. The venturi channel 920 fluidly couples the plenum 810, chemical additive module 813 and the venturi component 808 via aligning the channel portion in each component such that an amount of fluid from the plenum 810 can travel through the venturi channel 920 and ultimately enter the internal module body cavity 806 (via exhaust port 811) of fluid mixing module 801.

FIG. 9A, FIG. 9B and FIG. 9C present cross-section views of filter canister 102a and fluid mixing module 801 components, in accordance with a non-limiting exemplary embodiment of the invention. Specifically, FIG. 9A depicts a cross-section view of filter canister 102a similar to the depiction in FIG. 8, and FIG. 9B depicts a close-up view of venturi component 808, chemical additive module 813 (which houses a check valve 926) and plenum 810. In at least one embodiment of the invention, the chemical additive module 813 and the plenum 810 are coupled, and this coupled set of components can be additionally coupled to the filter canister 102a by snap rings 922. Further, FIG. 9C depicts an example flow path in accordance with at least one embodiment of the invention. Accordingly, while referencing the various components identified in FIG. 9A and FIG. 9B, the example flow path illustrated in FIG. 9C is described below.

As fluid is directed into the filter canister 102a through the through-holes 888 of the interlocking canister member 190 (arrows 990), the fluid travels through a region surrounding the fluid mixing module 801 within the filter canister 102a (arrows 991) and into the venturi component 808 (arrows 992). The fluid picks up speed at the venturi component 808, and the venturi component 808 creates a pressure differential (locally). As a result, contents are drawn from the plenum 810 (arrows 993) into the venturi component 808 (arrow 994) via check valve 926 and through the venturi channel 920, creating a fluid mixture of the drawn amount from the contents of plenum 810 and the fluid that had traveled into the venturi component 808 from the filter canister 102a. The check valve 926 (which can comprise a duckbill check valve including a silicon flap) is incorporated so that the fluid does not travel in the other direction (that is, back into the plenum 810) when there is static pressure present.

This fluid mixture subsequently travels out of the venturi component into the internal module body cavity 806, via exhaust port 811, (arrow 995) of fluid mixing module 801. The fluid mixture can then travel through the internal module body cavity 806 (arrow 996) and out of the fluid mixing module 801 (arrow 997) via the central opening 185 of media adapter cap 180 (and, for example, ultimately to the manifold body 110 of a filtration apparatus). Further, in at least one embodiment of the invention (and as described in connection with FIG. 10), module body cavity contains a mixing column 1003. The fluid mixture, upon entering the internal module body cavity, travels through the mixing column. The mixing column enhances the mixing and/or provides sufficient time to kill most viruses and bacteria in the primary (non-plenum) fluid.

FIG. 10 presents an example mixing column 1003, in accordance with a non-limiting exemplary embodiment of the invention. It is to be appreciated by one skilled in the art that mixing columns can include various configurations and sizes, and that FIG. 10 simply depicts example mixing column 1003 as well as an example flow path 1007 through a section of the mixing column 1003.

Further, as noted in connection with FIG. 8, a mixing column such as mixing column 1003 can be displaced within the internal module body cavity 806 of fluid mixing module 801, with outlet 1005 fluidly coupled to the central opening 185 of media adapter cap 180. As detailed herein, a mixing column can provide a sterilization composition such as chlorine (as it travels through a configured flow path such as 1007) to sufficiently mix with the primary fluid prior to exiting the fluid mixing module 801.

Accordingly, as described herein, an example embodiment of the invention includes providing the ability to dose an amount of a composition such as a sterilization agent such as chlorine into the water in a water filter system. The dosage is controlled in part by the given geometry of the venturi component 808. As such, for a given geometry, liquid such as chlorine can be drawn from the plenum 810 at a particular rate. By way of example, a user may desire to draw one part per million (ppm) for an 8% solution of chlorine.

By way of example, the plenum 810 can serve as a replacement cartridge for existing filter canisters. With an independent plenum component, a user can have a set concentration solution of, for example, a sanitizing agent such as chlorine, and the independent plenum component can be attached to the canister 102a, which includes the venturi component 808 (with a pre-determined/fixed geometry) that can draw fluid at a specified rate. Accordingly, the geometry of the venturi component 808 controls the rate at which fluid is drawn from the plenum 810 into the system, and the dosage of the drawn plenum composition is a combination of the rate at which the fluid is drawn and the concentration of the fluid solution in the plenum 810. It should be acknowledged by one skilled in the art that with a fixed venturi component geometry, the concentration of the solution in the plenum can be modified to obtain a desired dosage for the water filter system.

Further, at least one embodiment of the invention can include a plenum made from a clear material so as to enable the amount of fluid inside to be visible to a user (to indicate to a user the level of fullness or emptiness of the plenum).

Also, the check valve 926 can additionally serve as a flow valve, meaning that the check valve 926 can be a flow restrictor to maintain the flow constant for a range of pressures.

Thus, while there have shown and described and pointed out fundamental novel features of the invention as applied to exemplary embodiments thereof, it will be understood that various omissions and substitutions and changes in the form and details of the devices illustrated, and in their operation, may be made by those skilled in the art without departing from the spirit of the invention. Moreover, it is expressly intended that all combinations of those elements and/or method steps which perform substantially the same function in substantially the same way to achieve the same results are within the scope of the invention. Furthermore, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. An apparatus comprising:
a canister comprising a venturi component, wherein the venturi component comprises a check valve and a channel defined in the venturi component coupling the check valve to an interior cavity of the canister.

2. The apparatus of claim 1, further comprising a plenum that is connectable to the canister.

3. The apparatus of claim 2, wherein the plenum comprises a snap-on interface.

4. The apparatus of claim 2, wherein the plenum comprises a channel defined therein.

5. The apparatus of claim 4, wherein the channel defined in the venturi component fluidly couples the plenum and the venturi component via aligning with the channel defined in the plenum.

6. The apparatus of claim 2, wherein the plenum is connectable to the canister such that fluid is drawn from the plenum upon a pressure differential being created via the venturi component.

7. The apparatus of claim 1, further comprising a canister interlocking member, wherein the canister interlocking member comprises one or more through-holes defined on a surface thereof

8. The apparatus of claim 7, wherein the canister interlocking member comprises a media adapter cap coupled thereto.

9. The apparatus of claim 7, wherein the media adapter cap comprises a central opening defined therein.

10. The apparatus of claim 9, further comprising a fluid mixing module displaced within the canister, the fluid mixing module comprising an exhaust port defined thereon.

11. The apparatus of claim 10, wherein the venturi component is connectable to the exhaust port of the fluid mixing module.

12. The apparatus of claim 10, wherein the fluid mixing module is connectable to the central opening defined in the media adapter cap.

13. The apparatus of claim 1, wherein the check valve comprises a silicon duckbill check valve.

14. The apparatus of claim 1, further comprising a mixing column displaced within the canister.

15. An apparatus comprising:
a canister comprising a venturi component, wherein the venturi component comprises a check valve and a channel defined in the venturi component coupling the check valve to an interior cavity of the canister; and
a plenum fluidly coupled to the venturi component via the channel defined in the venturi component such that the check valve only permits fluid to travel from the plenum into the canister.

16. The apparatus of claim 15, further comprising a fluid mixing module displaced within the canister, the fluid mixing module comprising an exhaust port defined thereon.

17. The apparatus of claim 16, wherein the venturi component is connectable to the exhaust port of the fluid mixing module.

18. The apparatus of claim 16, further comprising a mixing column displaced within the fluid mixing module.

19. The apparatus of claim 15, further comprising a mixing column displaced within the canister.

20. A fluid filtration system comprising:
a manifold having a manifold inlet port and a manifold outlet port, a check valve disposed for fluidly sealing at least one of said ports, a flow inlet channel leading to the check valve, the manifold inlet port being operably fluidly coupled to a fluid source for receiving a flow of fluid and to a flow inlet channel, the manifold outlet port being fluidly coupled to a flow outlet channel;
the flow inlet channel having an intake opening for directing fluid conveyed therein, the intake opening defined in a margin of a depending inlet boss of the manifold; and
an outlet boss depending from the inlet boss and having a circumferential outer margin, the outlet boss also having an outlet opening for directing fluid conveyed therein, the outlet opening being fluidly coupled to the flow outlet channel, the flow outlet channel fluidly coupling the outlet opening to the manifold outlet port; and
a canister comprising a venturi component, wherein the venturi component comprises a check valve and a channel defined in the venturi component coupling the check valve to an interior cavity of the canister.
